(19) United States
(12) Patent Application Publication
(10) Pub. No.: US 2026/0041613 A1
(43) Pub. Date: Feb. 12, 2026

(54) PROPORTIONALLY WEIGHTED SELF BALANCING PACIFIER INFANT SOOTHING DEVICE

(71) Applicant: Jillian Alex Dorazio, Toronto (CA)

(72) Inventor: Jillian Alex Dorazio, Toronto (CA)

(21) Appl. No.: 18/798,039

(22) Filed: Aug. 8, 2024

(51) Int. Cl. A61J 17/00; A61J 17/02

(52) U.S. Cl. CPC A61J 17/001; A61J 17/02

(57) ABSTRACT

A pacifier or infant soothing device which operates or functions to soothe an infant having discomfort, stress, or otherwise and where a portion of the device is inserted into the mouth of an infant user and where the device is configured to maintain the top portion thereof in an upright position when superposed on a support surface. The device includes a body having an integrally formed bottom portion and top portion. The top portion is provided in a first embodiment and second embodiment being a nipple member or a teething ring member. The bottom portion has an outer surface wherein the outer surface has disposed thereon a gripping member. Formed in the bottom portion at the lower end thereof is a proportionately weighted distribution element which has a density to facilitate the top portion from engaging or touching the ground, floor, or other surface when placed, dropped or fallen thereon.

### FIELD OF THE INVENTION

The present invention relates generally to a pacifier or device which is utilized to calm, comfort, or soothe an infant, more specifically but not by way of limitation, a pacifier having one embodiment with a top portion and which pacifier includes a bottom portion having a weight distribution element integrally formed therein that provides an automated or self-balancing and upward orientation of the top portion of a pacifier when dropped, tossed, discarded, or otherwise fallen to the ground, floor, or other surface.

### BACKGROUND

This Patent Application means to include the entire contents of this document and as referred herein. A word, phrase, or term which is defined or described herein means as follows, unless the context clearly requires otherwise: if singular, to include the plural, and vice versa, to be gender inclusive, and which thereof may include a corporation or company, registered or otherwise, to include a similar or equivalent word, phrase, or term, a reference to “typical” or “typically” to describe language, for example only such as typically made or a typical material, is not to be interpreted as all-inclusive, unless the context specifically dictates otherwise, to refer to a device, object, item, article, material, methodology, or otherwise, or the like will apply in the broadest sense possible and be expanded by any means to be all-inclusive. Such examples of an application being all-inclusive may apply, whether typical or not, to the following: the manufacture, shape, form, use, method, type, or otherwise, a size which may be necessary by its context, a material such as rubber, silicone, latex, or plastic, or other material which includes a gel, liquid, or other such matter, a pliable texture which may include moldable or a soft texture which may include stiff and hard and so on with other such descriptive language and to refer to a device, object, item, article, material, methodology, or otherwise, or the like and which thereof may be described in the appropriate context by more than one word, phrase, or term or a combination thereof. Such examples of being more than one or a combination thereof may apply to: a device which is described to be flat, round, conical, oval, spherical, circular or otherwise, or the like which may, in the appropriate context, have more than one shape or a combination of shapes, such as being both flat and round for different parts of such device and in any proportion thereof, an object, item, article, material, methodology, or otherwise, or the like which may, in the appropriate context, include more than one descriptive word, phrase, or term or a combination thereof and similarly with other such descriptive language, to include being construed or expressed as an approximation, to include slang which has a similar or equivalent meaning, to include regional or cultural language which has a similar or equivalent meaning, to include that which is currently known or defined. However, it should be understood that in the future a new word, phrase, or term may become an alternative to or a substitute for that thereof which is currently known or defined, and where in such a situation such new word, phrase, or term should be automatically accepted as being the same, similar, or equivalent to that which is currently known or defined, to include a conjunction word in the most inclusive sense possible. As an example, the word “or” as used herein should be understood to have the definition of a logical “or” rather than that of a logical “exclusive or”, if a word, phrase, or term is not defined or described herein, that thereof is to be construed in accordance with the most common language and which thereof will apply in the broadest sense possible and be expanded by any means whatsoever to be all-inclusive language: “infant” includes an infant, baby, toddler, child, young child, or any person who may have the need for the use of a pacifier as defined later herein; “caretaker” includes any person who is responsible for the care, safety, and well-being of an infant, and which care usually includes feeding or pacifying; “to soothe” includes to soothe, calm, comfort, settle, pacify, or otherwise to quiet an upset, cranky, distressed, or otherwise unhappy infant; “pacifier” includes a pacifier, infant soothing device 100, soother, toy object, or such other child soothing device which has a nipple or a teething ring, of an appropriate size, on the top part, and which nipple or teething ring is used to soothe an infant. A pacifier, often called a dummy or soother in some regions, has a nipple-shaped top, which is designed for an infant to suck on, and is typically made of rubber, silicone, latex, plastic, or other material. A pacifier, often called a teether, has a teething ring top, which is designed for an infant to bite or teeth on, and is typically made of rubber, silicone, latex, plastic, or other material. A pacifier with a nipple is used to soothe or otherwise pacify an infant by satisfying their natural sucking instinct with a nipple providing comfort and at times helping an infant to fall asleep. A pacifier with a nipple has three parts: a nipple or elongated teat, a mouth shield, guard, or base, a gripping member or handle, which may be optional. A pacifier with a nipple will have a nipple on the top part and a proportionally weighted self-balancing mechanism on the bottom part. A pacifier with a teething ring is used to soothe or otherwise pacify an infant by the biting upon to soothe its gums, lips, or teeth. A pacifier with a teething ring has two parts: a teething ring, a gripping member or handle, which may be optional. A pacifier with a teething ring will have a teether on the top part and a proportionally weighted self-balancing mechanism on the bottom part. A pacifier as described herein is designed to be self-balancing when it is dropped, tossed, discarded, or has otherwise fallen (and all of which thereof may be referred to as “fallen” herein). A pacifier may be made of a natural material such as an eco-friendly material such as natural rubber, bamboo, or wood. A pacifier that is BPA-free does not contain any trace of Bisphenol-A. “Nipple” includes a nipple, teat, or the top part of a pacifier and which part can be of any size or shape and is typically made of rubber, plastic, silicone latex, or other material and upon which part an infant will naturally suckle between feedings or at other times to quiet or soothe themselves. A nipple is designed to mimic the shape and feel of a mother's breast nipple or teat and is typically made of a soft, flexible material which is shaped to fit comfortably in the mouth of an infant. A nipple may be soft and pliable, hard and rigid, or otherwise to provide comfort to an infant while they suck on it. A nipple is an essential part of a pacifier fulfilling the natural sucking instinct to soothe an infant. Plastic elastomers (TPE) is a flexible and soft material which is sometimes used for a nipple of a pacifier. Other materials are also used. “Shield, guard, or base” includes that part of a pacifier to which a nipple is attached and which part assists to keep a nipple in place and prevents a pacifier from being fully inserted into the mouth of an infant or being swallowed by an infant or to keep an infant from choking thereon. A shield, guard, or base, often prefaced by the word mouth, may include ventilation holes to allow airflow around the mouth of an infant, and which shield is typically made of rubber, plastic, silicone, latex, or other material. A proportionately weighted distribution element is attached to the shield, guard or base which can be of varying size, weight and shape. As examples of the types of plastic which are used for a mouth shield guard, or base of a pacifier are polypropylene (PP) and polyethylene (PE). Thermos plastic elastomers (TPE) includes a flexible material which is sometimes used for a mouth shield of a pacifier. A food grade stainless steel is another type of material which is used for a mouth shield, guard, or base of a pacifier. “Gripping member” or “gripping members” includes a part of a pacifier which is a gripping member, grip, handle, textured surface, ergonomic shape, or the like that can be held or grasped by an infant or caretaker. A gripping member is designed to make it easier for an infant or caretaker to maneuver or manipulate a pacifier thereby keeping a nipple, in the mouth of an infant. A gripping member refers to the small protrusions or ridges on a pacifier that assist an infant to grasp and hold onto a pacifier securely. A gripping member also assists an infant or caretaker to provide a comfortable and secure fit of a nipple or teething ring in the mouth of an infant, and thereby making it easier for an infant to use a pacifier to self-soothe themselves or assist them to fall asleep. A gripping member also prevents a pacifier from falling out of the mouth of an infant, and thereby reducing the need for frequent cleaning or re-insertion, and thereby providing a safe and effective way to meet the sucking or teething needs of an infant. A gripping member on a pacifier is optional. “Hemispherical” includes a hemispherical shape or form, or a half sphere, half dome, or a roughly spherical body which is used for a pacifier. This shape provides a wide base and low center of gravity making it stable. The actual shape of a hemispherical item may vary and be typically flat, round, conical, circular, oval, spherical, egg-like, or otherwise, and the bottom part or hemispherical shape of a pacifier is designed to provide a level of stability which allows a pacifier to wobble or roll while ultimately settling in an upright position. A low center of gravity also assists in making this happen. The bottom half of a hemispherical shaped pacifier may be made with such variations in shape and offer differing levels of stability. When a pacifier is dropped, tossed, discarded, or has otherwise fallen, the weight distribution thereof and its hemispherical shape creates a motion that pulls, pushes, or otherwise causes a pacifier to revert to an upright position. The bottom portion of a pacifier is proportionately weighted so a nipple or teething ring portion or top of a pacifier lands upright due to its unique design and physics. A heavier bottom and lighter top with a low center of gravity ensures that the top portion will most always return to an upright position, as it is designed to do most of the time, and which function is a key component of the present invention. “Gyroscopic” as it relates to the design of a pacifier describes a function when fallen, with a roll or wobble and where the weighted base of a pacifier creates a gyroscopic effect by a gyroscopic self-balancing motor which assists a pacifier to rotate and orient itself upward, and with the nipple, or teething ring portion, not resting on the surface upon which a pacifier may have fallen. Basically, the above creates a stabilizing force that keeps a pacifier upright by using a self-righting small mechanical mechanism which is incorporated into a pacifier which uses gravity and rotation to orient a falling pacifier upright on landing. When a pacifier is dropped, tossed, discarded, or has otherwise fallen, the rotation creates a gyroscopic effect which assists a pacifier to stabilize and return to an upright position. The surface upon which a pacifier will land creates friction which slows down its rotation and helps a pacifier to come to a stop in an upright position. “Teething ring” includes a teething ring, teether, or the top part of a pacifier and which part is somewhat like a nipple but unlike a nipple in that a teething ring performs a different purpose, function, or use which is that thereof for teething. A teething ring is an essential part of a pacifier fulfilling the natural biting instinct to soothe the gums, lips, or teeth of an infant. Therefore, a pacifier that includes a nipple on its top part is not the same product as a pacifier which includes a teething ring on its top part. A teething ring is also known by other descriptive language to mean the same, similar, or equivalent. A teether can be of any size or shape, and typically, wide and made of rubber, plastic, silicon, latex, other material and commonly in the shape of a ring, loop, hemispherical, semi-circle, toy, or such other shape of an object which is used by an infant to bite upon to soothe its gums, lips, or teeth. The wide size or shape of a teething ring is important as that prevents an infant from swallowing a teething ring or choking on it. A teether may also be filled with a liquid or gel that can be chilled in a refrigerator or freezer and where the cold gel or liquid provides additional relief to an infant during teething or dentition. A teething member is sized or configured to conform to the shape of the alveolar ridge or mouth bone of an infant. “Structure” refers to a functional equivalent of such structure as described or used herein, and known to those skilled in the art. “Element” includes one or more components, parts, or equivalents as described or used herein, and known to those skilled in the art. A section or clause heading or underlining herein is for convenience only and does not define or limit the scope or intent of the present invention. “Present invention” includes the invention described in this Patent Application.

The care of an infant requires a great deal of effort, and a caretaker must perform numerous tasks. Routine tasks such as, but not limited to, hygiene, feeding, or pacifying can occur numerous times per day. An infant also needs emotional support, and the expression thereof often comes in the form of whining, crying, or other manner of upset. Additionally, as an infant grows, growing pains, teething, or other similar challenges and discomfort can occur during such an experience, and whereby a caretaker will employ many and varying or alternate techniques or devices to soothe an infant.

One device commonly utilized to pacify an infant is a pacifier. As known in the art, a pacifier consists of two integrally formed portions. A top portion of a pacifier is a nipple that can be inserted or placed into an infant's mouth and where an infant will instinctively suck on a nipple to soothe themselves. A bottom portion of a pacifier typically includes a gripping member or structure that an infant can hold or grasp. Often, an infant will, consciously or unconsciously, throw a pacifier away from themselves and in doing so a pacifier frequently lands on the ground, floor, or other surface which may not be clean. Ensuing contact with the ground, floor, or other surface may cause a nipple on the top portion of a pacifier, or a pacifier, to become contaminated with bacteria, or be otherwise unhygienic, unhealthy, dirty, or have an odd or unusual taste or smell, and where a caretaker tends to clean or wash a nipple, or pacifier, prior to inserting or placing a nipple back into the mouth of an infant. Another common device utilized to soothe an infant is a teething ring, which is unlike a nipple as described herein. As with a nipple, an infant will often drop, toss, or otherwise discard or cause the falling of a teething ring onto the ground, floor, or other surface, and similarly requiring a caretaker to clean or wash a teething ring prior to inserting or placing a teething ring back into the mouth of an infant, or for an infant to use a teething ring.

Accordingly, there is a need for an infant pacifier, and likewise a teething ring, and where each of them is a separate device that is configured or shaped to provide a somewhat seemingly natural or automated manner to end upright positioning of the top portion of a pacifier so that when dropped, tossed, discarded, or otherwise fallen to the ground, floor, or other surface, the top portion of a pacifier, nipple or teething ring, is inhibited from contacting the ground, floor, or other surface. This motion which allows a pacifier, nipple or a teething ring, to land upward is a key element of the present invention.

### SUMMARY OF THE INVENTION

It is the object of the present invention to be a pacifier or device which is configured or shaped to be utilized by an infant to soothe themselves and where such pacifier or device includes a body having a top portion and a bottom portion.

Another object of the present invention is to be a pacifier or device which is utilized to soothe an infant by inserting a top portion of a pacifier, a nipple or teething ring, into the mouth of an infant and where such pacifier or device includes a top portion of the present invention which is provided in at least two embodiments.

A further object of the present invention is to provide a pacifier or device which is configured or shaped to be utilized by an infant to soothe themselves and where one embodiment of a top portion of the present invention is a nipple or teething ring.

Yet a further object of the present invention is to provide a pacifier or device which is to be utilized to soothe an infant by inserting a portion of a pacifier into the mouth of an infant and where a second embodiment of the top portion of the present invention is a shield, guard, or base.

Still another object of the present invention is to provide a pacifier or device which is configured or shaped to be utilized by an infant to soothe themselves and where the bottom portion of the body of the present invention is hemispherical in form or shape.

An additional object of the present invention is to provide a pacifier or device which is utilized to soothe an infant by the inserting or placing of a nipple or teething ring portion of a pacifier into an infant's mouth by themselves or having it inserted or placed by a caretaker, and where the bottom portion of the body of the present invention or pacifier includes a gripping member on the outer surface of a pacifier.

Yet a further object of the present invention is to provide a pacifier or device which is configured or shaped to be utilized by an infant to soothe themselves and wherein the bottom portion of the body of the present invention includes a proportionately weighted distribution element formed as a part of such device.

To the accomplishment of the above and related object of the present invention may be embodied in the form which is illustrated in the accompanying or similar Drawings. Attention is called to the fact that such Drawings are for illustrative purposes only. Variations of a pacifier or device are contemplated as being a part of the present invention which is limited only by the scope of the Claims. It should be noted that a pacifier with a nipple is similar to a pacifier with a teething ring in some ways and distinctly different in other ways. As it pertains to the present invention, a pacifier with a nipple or a teething ring are separate products. In this regard a pacifier has three primary components as outlined herein, a nipple, a shield, guard, or base, and a gripping member, although a gripping member is optional. A teething ring on the other hand has two primary components as outlined herein, a teether and a gripping member, although a gripping member is optional.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention; and

FIG. 2 is an end view of an embodiment of the present invention; and

FIG. 3 is a perspective view of an alternate embodiment of the present invention.

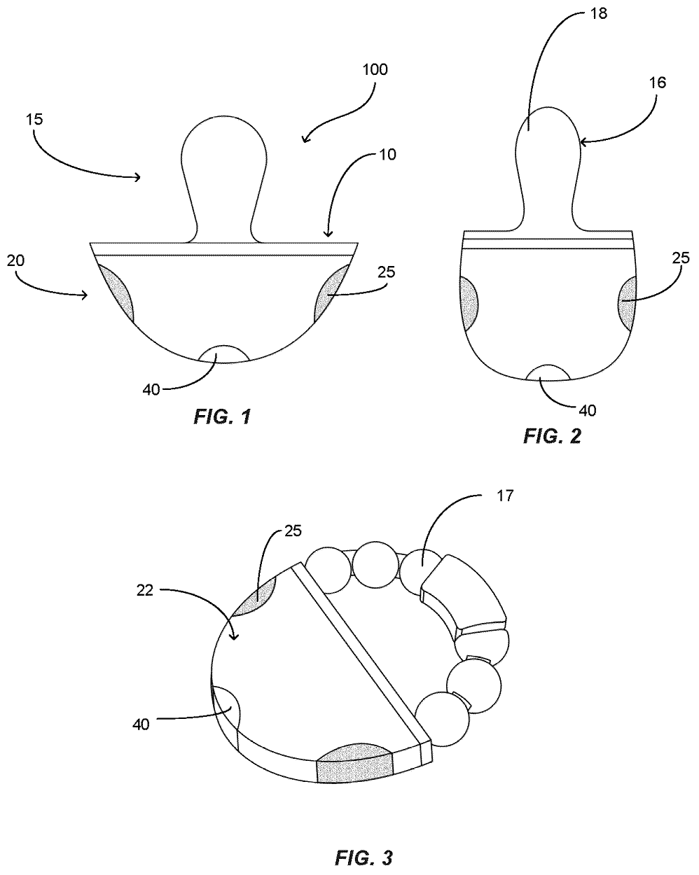

### DETAILED DESCRIPTION

Referring to the accompanying Drawings herein, and where various elements depicted are not necessarily drawn to scale and wherethrough the views and Figures like elements are referenced with identical reference numerals, there is an illustrated pacifier or infant soothing device 100 constructed according to the principles of the present invention.

An embodiment of the present invention is discussed herein with reference to the Figures submitted herewith. Those skilled in the art will understand that the Detailed Description herein with respect to these Figures is for explanatory purposes only and that it is contemplated within the scope of the present invention that alternative embodiments are plausible. By way of example but not by way of limitation, those having skill in the art considering the present teachings of the present invention will recognize a plurality of alternate and suitable approaches dependent upon the needs of the application to implement the functionality of any given detail described herein, beyond that of the implementation choices in the embodiment described herein. Various modifications and embodiments are within the scope of the present invention.

It is to be further understood that the present invention is not limited to the particular methodology, materials, uses, applications, or the like as described herein, as these may vary. Furthermore, it is also understood that the terminology used herein is used for the purpose of describing embodiments only and is not intended to limit the scope of the present invention. It must be noted that as used herein, and in the Claims, the singular forms “a”, “an” and “the” include the plural reference, unless the context clearly dictates otherwise.

References to “one embodiment”, “an embodiment”, “exemplary embodiments”, or any other embodiment, or the like may indicate that the embodiment of the present invention so described herein may include a particular feature, structure, or characteristic, but not every embodiment necessarily includes such feature, structure, or characteristic.

Referring to the Figures submitted herewith, a pacifier or infant soothing device 100 is configured to be utilized to provide comfort to or to soothe an infant where an infant may be in discomfort for any number of reasons. It should be understood within the scope of the present invention that a pacifier is manufactured from food grade plastics or other non-toxic chemicals or such other materials or elements to be safe for insertion into the mouth of an infant. It should further be understood within the scope of the present invention that a pacifier could be provided in alternate sizes, colors, shapes, forms, or types.

A pacifier or infant soothing device 100 includes a body 10 wherein the body 10 is comprised of an integrally formed top portion 15 and bottom portion 20. The top portion 15 and bottom portion 20 are integrally formed utilizing suitable manufacturing techniques and components. The top portion 15 is provided in a first embodiment 16 and a second embodiment 17. The first embodiment 16 includes a nipple member 18 wherein a nipple member 18 is manufactured from a soft and pliable, or any other suitable material, and is configured to be inserted into the mouth of an infant for the sucking or chewing thereon. A nipple member 18 is provided in a somewhat conventional shape but it is contemplated within the scope of the present invention that a nipple member 18 could be provided in an alternate shape and size. The second embodiment of the top portion 15 is a teething ring member 17. A teething ring member 17 is somewhat of a conventional teething ring wherein a teething ring member 17 is manufactured from a soft and pliable, or any other suitable material, having shapes that are designed to engage and massage any part of the mouth of an infant, such as the gums, lips, or teeth, for the purpose known as teething. It should be understood within the scope of the present invention that a teething ring member 17 could be provided in alternate sizes, colors, or shapes.

A pacifier or infant soothing device 100 includes a body 10 wherein the bottom part of the body 10, the bottom portion 20 of the body 10 is hemispherical in shape and is manufactured from a soft and suitable, or any other material, such as but not limited to rubber, silicone or plastic. The bottom portion 20 includes an outer surface 22 wherein the outer surface 22 has formed thereon a gripping member 25. A gripping member 25 is manufactured from an alternate material which provides increased frictional engagement and as such enables an infant user of a pacifier or infant soothing device 100 an improved ability to maintain a hold or grip of the body 10. It should be understood within the scope of the present invention that the bottom portion 20 could have an alternate quantity of gripping members 25 disposed on the outer surface thereof. Furthermore, it is contemplated within the scope of the present invention that the outer surface 22 could be substantially coated with a gripping member 25. It is further contemplated within the scope of the present invention that a gripping member 25 could be a handle in the form of a ring, loop, oval, or other such shape or object

Formed at the lower end of the bottom portion 20 is a proportionately weighted distribution element 40 which is positioned at the lower end to facilitate a pacifier or infant soothing device 100 to maintain an upright position subsequent being present on a support surface. In the upright position of a pacifier or infant soothing device 100, the top portion 15 is maintained in an orientation wherein the top portion 15 will not engage the support surface on which a pacifier or infant soothing device 100 has been either placed, dropped, discarded, or otherwise fallen. In the upright position the top portion 15 maintains a position such that the top portion 15 is generally perpendicular with the support surface on which a pacifier or infant soothing device 100 is located. The proportionately weighted distribution element 40 accomplishes this by having a density and mass that is at least five times the density of the body 10. While in a preferred embodiment the proportionately weighted distribution element 40 has a density and mass five times the density and mass of the body 10, it is contemplated within the scope of the present invention that the proportionately weighted distribution element 40 could have a density and mass either less than or greater than five times the density and mass of the body 10. It is also contemplated within the scope of the present invention that any number of alternate materials could be utilized to manufacture the proportionately weighted distribution element 40. Furthermore, in addition to a higher density material, it is contemplated within the scope of the present invention that the proportionately weighted distribution element 40 could be manufactured from alternate materials or elements. By way of example but not limitation, the proportionately weighted distribution element 40 could be a refillable fluid filled chamber or a gyroscopic balancing motor or other item for such purpose.

In the preceding Detailed Description, reference has been made to the accompanying Drawings which form a part hereof, and in which Drawings are shown by way of illustration specific embodiments in which the present invention may be practiced. These embodiments, and certain variants thereof, have been described in sufficient detail to enable those skilled in the art to practice the present invention. It is to be understood that other suitable embodiments may be utilized and that logical changes may be made without departing from the spirit, scope, or intent of the present invention. The description may omit certain information known to those skilled in the art. The preceding Detailed Description is, therefore, not intended to be limited to the specific forms set forth herein, but instead, it is intended to cover such alternatives, modifications, variances, or equivalents, as can be reasonably included within the spirit, scope, or intent of the appended Claims.

What is claimed is:

1. A pacifier as a soothing device configured to have a portion thereof inserted into the mouth of an infant whereby such device is comprised of:
a body, said body having a top portion and a bottom portion;
with the top portion and the bottom portion being integrally formed;
with the top portion having a first embodiment and a second embodiment;
with the bottom portion being hemispherical in shape;
with the bottom portion having an outer surface and a proportionately weighted distribution element or component;
with the proportionately weighted distribution element being located at a lower end of the bottom portion distal to the top portion;
with the proportionately weighted distribution element being integrally formed in the lower end of the body; and
with the proportionately weighted distribution element having a density and mass greater than that of the body.

2. A pacifier or infant soothing device configured to have a portion thereof inserted into the mouth of an infant as recited in claim 1,
wherein the outer surface of the bottom portion further includes a gripping member or handle disposed thereon, and which thereof may be one or more.

3. A pacifier or infant soothing device configured to have a portion thereof inserted into the mouth of an infant as recited in claim 2, wherein the first embodiment of the top portion of the body is a nipple member.

4. A pacifier or infant soothing device a teething ring is configured to have a portion thereof inserted into the mouth of an infant as recited in claim 2, wherein the second embodiment of the top portion is a teething ring member.

5. A pacifier or infant soothing device configured to have a portion thereof inserted into the mouth of an infant as recited in claim 3, wherein the proportionately weighted distribution element has a density and mass five times greater than a density and mass of said body.

6. A pacifier or infant soothing device configured to have a portion thereof inserted into the mouth of an infant as recited in claim 3, wherein the weight distribution element is a refillable fluid filled chamber.

7. A pacifier or infant soothing device configured to have a portion thereof inserted into the mouth of an infant as recited in claim 3, wherein the weight distribution element is a gyroscopic motor.
